(19) United States
(12) Patent Application Publication
(10) Pub. No.: US 2022/0383319 A1
(43) Pub. Date: Dec. 1, 2022

(54) MULTI-FACTOR AUTHENTICATION SECURITY SYSTEM AND METHOD FOR VERIFYING IDENTIFICATION USING EVOLVING PERSONAL DATA COMBINED WITH BIOMETRICS

(71) Applicants: Roger W. Ach, II, Cincinnati, OH (US); Charlie Buford Kerns, III, Frisco, TX (US); Christopher Lee Burnett, Batavia, OH (US)

(72) Inventors: Roger W. Ach, II, Cincinnati, OH (US); Charlie Buford Kerns, III, Frisco, TX (US); Christopher Lee Burnett, Batavia, OH (US)

(21) Appl. No.: 17/804,678

(22) Filed: May 31, 2022

Related U.S. Application Data
(60) Provisional application No. 63/202,164, filed on May 28, 2021.

(51) Int. Cl. G06Q 20/40; G06Q 20/38; H04L 9/40

(52) U.S. Cl. CPC G06Q 20/4014; G06Q 20/382; H04L 63/08; H04L 2463/082

(57) ABSTRACT

A method for generating and authenticating a user account in a system including entering personal information into the system of a vendor, selecting an image for the user account, selecting a personal identification number (PIN) for the user account, selecting a color for the user account, selecting a shape, selecting a word for the user account, recording audio for the user account, inputting biometric markers the user account, receiving a transaction information request for requested information in the system, verifying the requested information and matching account information of a requesting user to the user account in the system, determining if the requested information involves personal information previously entered into the system, beginning a user security setup, determining if a threshold in the user security setup exceeds a threshold requirement of a vendor security setup, determining if the user is authenticated, and sending requested information to the authenticated user.

### CROSS-REFERENCE TO RELATED APPLICATION

This application claims the benefit of priority of U.S. provisional application No. 63/202,164, filed May 28, 2021, the contents of which are herein incorporated by reference.

### BACKGROUND OF THE INVENTION

The present invention relates to biometrics, and more particularly, to a multi-factor authentication security tool that uses evolving personal data combined with biometrics to verify identification and generate a completely remote, contactless identification verification system.

Present security tools are limited with one- and two-factor authentication being hackable and very easily replicated. Systems that are in current use for protection are notably hacked and exposed almost weekly, showing their limited measures in place to protect data.

Further, currently, in order to do most things, or complete any transaction that requires a verified identification, one must be physically present for a given transaction, account, setup, or the like.

Biometrics have been used in electronic devices for years to verify users. However, those single metrics are easy to bypass to those that give effort.

Though biometric systems are functional, they are actually quite limited and lack the complexity that can prevent most fraud and error. Single metrics can be hacked, overridden, or bypassed in numerous ways that are limited by talent and curiosity. Multi-factor authentication is more complex but still limited in today's growing world of tech savvy threats where compromised accounts can expose numerous sites with the same credentials.

Other solutions in place are limited, with one- and two-factor authentication being hackable and very easily replicated. Such systems that are currently in use for identification system verification or protection are notably hacked and exposed almost weekly, showing their limited measures in place to protect data.

As can be seen, there is a need for a multi-factor authentication that evolves with the user and the incorporates the user's biometrics.

### SUMMARY OF THE INVENTION

In one aspect of the present invention, a method for generating and authenticating a user account in a system comprises entering personal information into the system of a vendor, selecting an image for the user account, selecting a personal identification number (PIN) for the user account, selecting a color for the user account, selecting a shape, selecting a word for the user account, recording audio and/or video for the user account, inputting biometric markers the user account, receiving a transaction information request for requested information in the system, verifying the requested information and matching account information of a requesting user to the user account in the system, determining if the requested information involves personal information previously entered into the system, beginning a user security setup, determining if a threshold in the user security setup exceeds a threshold requirement of a recipient security setup, determining if the user is authenticated, and sending requested information to the authenticated user.

These and other features, aspects and advantages of the present invention will become better understood with reference to the following drawings, description, and claims.

### BRIEF DESCRIPTION OF THE DRAWINGS

FIG. 1 is a flow chart of the account creation process in accordance with an exemplary embodiment of the present invention; and

FIG. 2 is a flow chart of the user authentication process in accordance with an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the present invention.

Broadly, an embodiment of the present invention provides a multi-factor authentication security tool that uses evolving personal data combined with biometrics to verify identification. The present invention provides a completely remote, contactless identification system verification.

A multi-factor authentication system of the present invention starts with no fewer than six elements collected from a user while the user creates a user account, such as, for example without limitation, audio, video, image, shape, color, word, phrases, and number. As each element is added, along with its respective data, the present invention becomes more unique to each user.

The present invention distinguishes over and differs from what has come before. The system of the present invention generates and provides a completely remote, contactless identification verification system. The present invention provides an unprecedented system, capable of collecting biometrics and data from a user's personal interaction to generate a security algorithm unique to each user. The present invention distinguishes over limited current biometric systems, which lack enough complexity to prevent most fraud and error. Single metrics can be hacked, overridden, or bypassed in numerous ways that are limited by talent and curiosity. Multi-factor authentication is more complex but still limited in today's growing world of tech savvy threats where compromised accounts can expose numerous sites with the same credentials.

The system may include at least one computer with a user interface. The computer may include at least one processing unit coupled to a form of memory. The computer may include, but may not be limited to, a microprocessor, a server, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieves technological improvements through the specific processes described more in detail below. In addition, the unconventional and unique aspects of these specific automation processes represent a sharp contrast to merely providing a well-known or routine environment for performing a manual or mental task.

In some embodiments, the present invention may provide a multi-factor authentication security system and method for verifying identification using evolving personal data combined with biometrics.

In some embodiments of the present invention, the system may include one or more of the following elements or components and combinations thereof.

1. A database, such as a collection of data available in the cloud.

2. A website, such as an interface for end-users to create accounts, access accounts, use authorization tools and the like.

3. A mobile device, such as a device for end-users to create accounts, access accounts, use authorization tools and the like.

4. A server, such as a cloud-based infrastructure to provide access to users and provide access to partners who may gain authorized access to an application programming interface (API) and a software development kit (SDK) for custom integration.

In some embodiments of the present invention, when accessing the website, the user may sign up for an account, and pieces of data and metadata collected may be collected and used for the present invention.

Steps for signing up or generating an account may include:

1. The user inputs “Know Your Client” (hereinafter “KYC”) Information. This information may be referred to as personal information and may include but is not limited to: a user's first name, last initial, social security number, birthdate, address, phone number, email address, the like, or combinations thereof;

2. The user selects an image or an avatar. The image or avatar may be private;

3. The user selects a key phrase. The key phrase may be selected from a list or may be a custom phrase. The key phrase may be a word, words, a phrase, or phrases;

4. The user records audio and/or video. The audio and/or video recorded may be key phrase;

5. The user selects a color. The color may be chosen from a plurality of colors including but not limited to: red, orange, lime, green, teal, light blue, blue, purple, or pink;

6. The user may select a shape. The shape may be chosen from a plurality of shapes including but not limited to: oval, circle, rectangle, square, triangle, hexagon, octagon, star;

7. The user may input a pin number. The pin number may be a four-to-twelve-digit number;

8. The user may select a “submit” button that completes an account creation by hashing all entries and uploading it to the database.

The order of the steps listed above is not particular to the present invention. Each selection made by the user during account creation form user selected criteria as part of the present invention. These user selected criteria may be accounted for upon generation of the user account as part of the multi-factor implementation with security remittance levels and, for actions, captured altogether or in sections as needed per remittance levels. Said remittance levels may be based on an account threshold, alternatively a threshold requirement. The threshold requirement may be selected by both the user and the vendor.

The account threshold may be determined by a minimum amount of entry or selection points a user must enter or select for authentication. Data points used of the threshold may include user selected criteria and biometric markers. Once the security system is setup, a user may be required to always enter or select all data points for authentication and/or access. Alternatively, the user may only be required to enter or select some of the data points. The user or a vendor, such as a site operator, may determine said threshold. The vendor threshold may override the user threshold.

In some embodiments of the present invention, not all data points will be entered by the user at a time of authentication. All data points may be passed and verified during the authentication process. Hence, a variety of data points, having all been passed and verified by the security system, may be chosen at random for authentication of a user. An addition of other simple factors and biometrics may allow added complexity while maintaining the user selected criteria for security.

All elements user selected criteria mixed with user biometric markers make the security of the present invention ever-evolving. As the user or the user's preferences change, so does the security of the present invention. As a user grows with more data and information, their security of the present invention evolves with them. Such enhancements may arise from adding biometric measurements. Capturing the elements in any order will provide the same results, as well as declaring random entries and default settings for remittance level entry. The user will be able to set security based on easy to remember personal preferences.

In some embodiments, the system of the present invention may provide a process that ultimately generates an image for the user, which holds all required information to verify the user and quantify the details of said user including but not limited to the user selected criteria. This may be used solely for authentication.

Meta data from a device used during registration may be added as a non-user-implemented security factor. This helps ensure cloning of devices may not be used later for breaching security of the present invention. A decoder image may be required as well to ensure proper comparison against user account. Any registration factors utilized may require a new public/private image set to be processed.

In some embodiments, the system may be run on a computer server that allows the process to render and verify the user based on entry points of the user selected criteria and accompanying biometric markers.

In some embodiments, the present invention may utilize a back-end server, a front-end html website with a user interface for access across all browsers, and a database that enables the reading and writing of data. The present invention may be built on an infrastructure, built to scale and adaptable to any environment size and/or capability.

In summary, the present invention provides a multi-factor authentication security system and method for verifying identification using evolving personal data combined with biometrics. The multi-factor authentication security system uses evolving personal data combined with biometrics to verify identification. The inventive multi-factor system starts with no fewer than six elements collected from the user as the user creates a user account, such as, for example without limitation, audio, video, image, shape, color, word, phrases, and number. As each element is added, along with its respective data, the algorithm becomes un-hackable and truly unique to each user.

The computer-based data processing system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

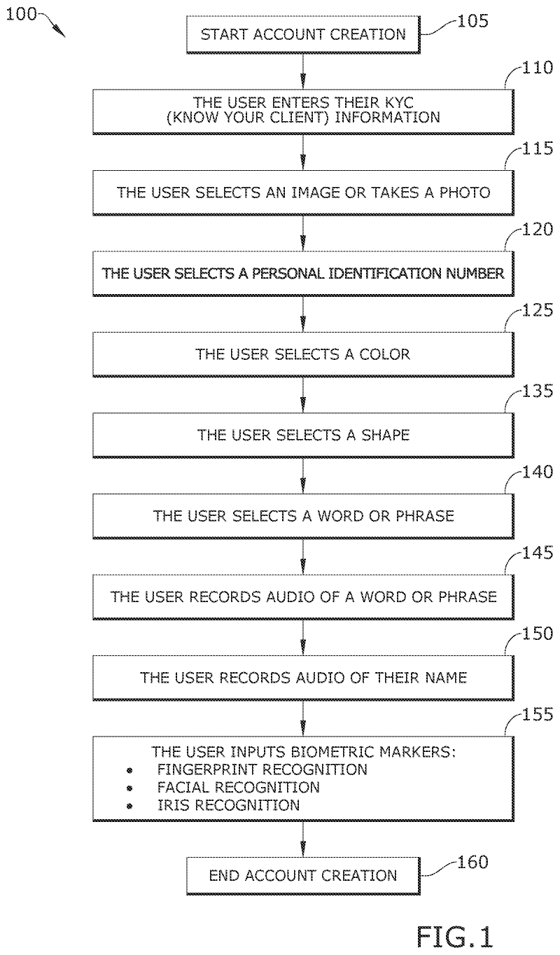

Referring to FIG. 1, a method 100 for a generation of a user account is shown according to an embodiment of the present invention. A user starts account creation 105. The user enters their Know Your Client “KYC” information. 110. The user selects an image or avatar 115. The user selects a personal identification number 120. The user selects a color 125. The user selects a shape 135. The user selects a word, phrase, or phrases 140. The user records audio and/or video of a word, phrase, or phrases 145. The user records audio and/or video of their name 150. The user inputs biometric markers from a group consisting of: fingerprint recognition; facial recognition; voice recognition; iris recognition, and a combination thereof 155. After the user makes all of the required selections, this ends the user account creation step 160.

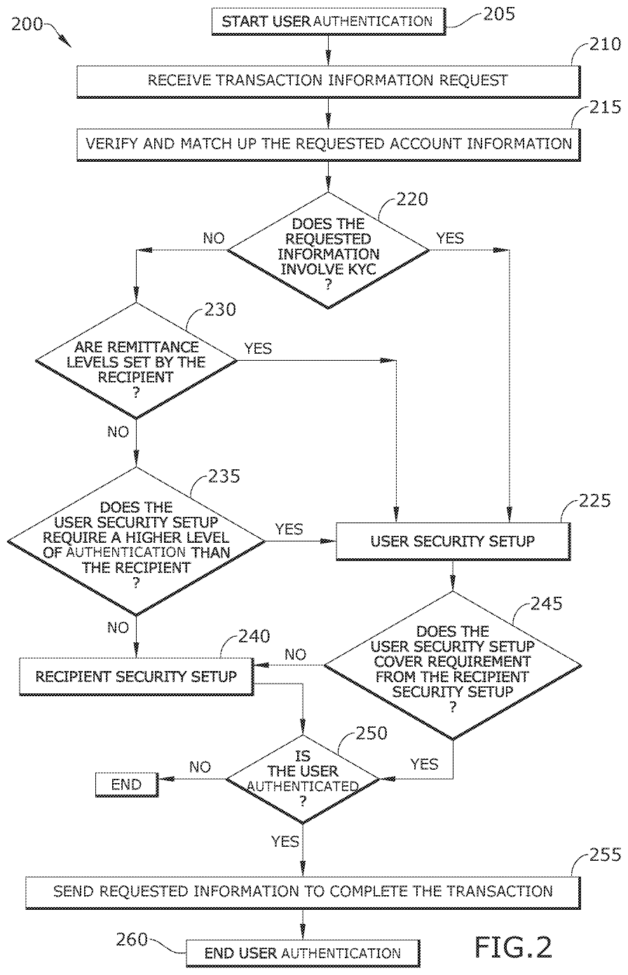

Once the user account has been created, the system may implement a security protocol as detailed in FIG. 2 for authentication of the user. The system comprises software constructed and in place to capture and process commands and actions. The software may operate to bring about one or more of the following steps or provide a method comprising one or more of the following steps and combinations thereof.

FIG. 2 shows a method of authenticating a user 200 according to an embodiment of the present invention. A user may start the authentication process 205 on a site or system of a vendor or a recipient. The system receives a transaction information request 210. The system verifies and compares the requested account information of a requesting user to the user account in the system 215. The system determines if the requested information involves KYC 22. If yes, the system begins a user security setup 225. The user security setup is a threshold of datapoints a user must enter or select for authentication. All datapoints may be entered into the system for a user security setup. However, if not, further authentication of a user may require utilization of all datapoints. If the requested information does not involve KYC, the system determines if remittance levels are set by the recipient 230. If yes, the system begins the user security setup 225. If no, the system determines if the user security setup requires a higher level of authentication than the recipient 235. If yes, the system begins the user security setup 225. If no, the system begins recipient security setup 240. In the recipient security setup, the user must enter an amount of datapoints to hit a threshold set by the recipient.

After the user security setup 225, the system determines if the user security setup cover requirement from the recipient security setup 245. If no, the system begins the recipient security setup 240.

After the recipient security setup 240 or if yes to 245, the system determines if the user is authentication 250. If no, the process ends. If yes, the system sends requested user information to the authenticated user and completes the transaction 255. This ends user authentication 260.

It should be understood, of course, that the foregoing relates to exemplary embodiments of the invention and that modifications may be made without departing from the spirit and scope of the present invention

What is claimed is:

1. A method for generating and authenticating a user account in a system comprising:
entering personal information into the system of a vendor;
selecting an image for the user account;
selecting a personal identification number (PIN) for the user account;
selecting a color for the user account;
selecting a shape;
selecting a word for the user account;
recording audio for the user account;
inputting biometric markers the user account;
receiving a transaction information request for requested information in the system;
verifying the requested information and matching account information of a requesting user to the user account in the system;
determining if the requested information involves personal information previously entered into the system;
determining a threshold of datapoints a user must enter for authentication;
determining if a threshold of datapoints the user must enter for authentication exceeds a threshold requirement of the vendor;
determining if the user is authenticated; and
sending requested information to the authenticated user.

2. The method of claim 1, wherein the word selected further comprises words, a phrase, or phrases.

3. The method of claim 1, further comprising recording video for the user account in conjunction with recording audio for the user account.

4. The method of claim 1, wherein the audio recorded is the selected word, phrase, or phrases.

5. The method of claim 1, wherein selecting an image further comprises uploading an image.

6. The method of claim 1, wherein the biometric markers consist of a group of: fingerprint recognition, facial recognition, iris recognition, voice recognition, and combinations thereof.

7. The method of claim 1, further comprising determining if remittance levels are set up by a vendor if the requested information involves personal information previously entered into the system.

8. The method of claim 7, further comprising determining if the threshold of datapoints a user must enter for authentication is higher than the threshold requirement of the vendor if remittance levels are not set up by the vendor.

9. The method of claim 8, further comprising a selection of further datapoints if the threshold of datapoints the user must enter for authentication is not higher than the threshold requirement of the vendor.
